(19) United States
(12) Patent Application Publication
(10) Pub. No.: US 2024/0419909 A1
(43) Pub. Date: Dec. 19, 2024

(54) Semantic Frame Identification Using Transformers

(71) Applicant: Cognizer, Inc., Pleasanton, CA (US)

(72) Inventors: Jack Porter, Valley Springs, CA (US); Rajiv Baronia, San Ramon, CA (US); Suzanne M Kirch, Waltham, MA (US); Vineeth Thanikonda Munirathnam, Bangalore (IN); Aditya Arun, Patna (IN)

(21) Appl. No.: 18/703,304

(22) PCT Filed: Oct. 18, 2022
(86) PCT No.: PCT/US22/46967

§ 371 Date: Apr. 19, 2024

(51) Int. Cl. G06F 40/284

(52) U.S. Cl. CPC G06F 40/284

(57) ABSTRACT

Semantic frame identification involves associating identified target words in the sentential context of their natural language source with semantic frames from a frame lexical database. The disclosed invention utilizes a transformer for semantic frame identification of a target word in a natural language input. Through the transformer's multi-headed attention mechanism, the model learns contextual relationships between words in an input text. The disclosed invention generates a list of potential substitute words for a target word and then verifies the context and meaning of the words in the list to identify a frame from a frame lexical database.

### CROSS REFERENCE TO RELATED APPLICATIONS

This application claims priority from provisional U.S. patent application No. 63/270,280 filed on Oct. 21, 2021.

### FIELD OF THE INVENTION

Embodiments of the invention generally relate to natural language processing, more particularly, to the usage of transformers for frame semantic parsing.

### BACKGROUND

Semantic parsing is the task of transforming natural language text into a machine-readable formal representation. Natural language processing (NLP) involves the use of artificial intelligence to process and analyze large amounts of natural language data. In natural language processing, semantic role labeling is the process of labeling words in a sentence to indicate their semantic role in the sentence. Moreover, frame semantic parsing has gained traction in recent years, where it uses the lexical information defined in FrameNet to first associate identified target words in the sentential context of their natural language source with semantic frames. Other similar forms of NLP are word sense disambiguation and word sense induction, which attempt to understand individual words and identify homographs as separate words. Semantic frame identification reduces the number of suitable semantic roles in the subsequent semantic role labeling step, thus improving the efficiency of the process. A better understanding of text through frame identification also results in improved question answering and text summarization.

The FrameNet database contains over 1,200 semantic frames, which define various situations represented by language. A single frame can correlate with many words, and a single word can correlate with many frames. For example, the word ‘right’ has several meanings, which correspond to different frames. This includes ‘correctness,’ ‘direction,’ ‘morality evaluation,’ and other frames related to synonyms of ‘right.’

Semantic frame parsing methods can include Bidirectional Encoder Representations from Transformers (BERT). BERT consists of a stack of transformers that are bidirectionally trained using self-attention. Existing models can utilize a frame filter, which improves a model's ability to understand familiar contexts but makes the model less generalizable, reducing its ability to handle never-before-seen targets. Other models that do not utilize a frame filter are better at generalizing and handling previously unseen targets but are highly sensitive to contextual variations, and with slight deviations from the standard context, the model can identify the frame incorrectly.

### SUMMARY

Semantic frame identification involves associating identified target words in the sentential context of their natural language source with semantic frames from a frame lexical database. The disclosed invention utilizes a transformer for semantic frame identification of a target word in a natural language input. Through the transformer's multi-headed attention mechanism, the model learns contextual relationships between words in an input text. The disclosed invention generates a list of potential substitute words for a target word and then verifies the context and meaning of the words in the list to identify a frame from a frame lexical database.

System, method, apparatus, and program instruction for identifying a semantic frame of a target word in a natural language text is provided. This includes receiving, into a transformer, a token vector, where the token vector contains tokens representing words in a natural language input text, generating one or more potential substitute words for the target word, generating, for each potential substitute word, a paraphrased text, that is a paraphrase of the input text with each potential substitute word, comparing each paraphrased text to the input text to determine whether the potential substitute word is a valid substitute word, and identifying one or more valid substitute words for the target word, from the one or more potential substitute words. It can further include identifying the semantic frame most in common among the valid substitute words.

The input can be a natural language text, where the words in the natural language text are converted into tokens and inserted into a token vector during pre-processing. The target word in the natural language text can be identified during pre-processing. The features of the natural language text can be identified during pre-processing.

### BRIEF DESCRIPTION OF THE DRAWINGS:

The accompanying drawings taken in conjunction with the detailed description will assist in making the advantages and aspects of the disclosure more apparent.

FIG. 1 depicts a system embodiment configured to identify a semantic frame corresponding to a target word in a natural language input.

FIG. 2 depicts a process of identifying a semantic frame corresponding to a target word in a natural language input using a transformer.

FIG. 3 depicts an alternative system embodiment configured to identify a semantic frame corresponding to a target word in a natural language input.

FIG. 4 depicts an alternative process of identifying a semantic frame corresponding to a target word in a natural language input using a transformer and neural network.

FIG. 5 depicts words in an input sentence converted to numerical representations called tokens.

FIG. 6 depicts sentence comparison by an attention layer to produce a binary output.

FIG. 7 depicts sentence comparison by a neural network layer to produce a binary output.

### DETAILED DESCRIPTION OF THE INVENTION:

Reference will now be made in detail to the present embodiments discussed herein, illustrated in the accompanying drawings. The embodiments are described below to explain the disclosed method, system, apparatus, and program by referring to the figures using like numerals.

The subject matter is presented in the general context of program modules and/or in computer hardware, including the structures disclosed in this specification and their structural equivalents, or in combinations of one or more of them. Those skilled in the art will recognize that other implementations may be performed in combination with other types of program and hardware modules that may include different data structures, components, or routines that perform similar tasks. The invention can be practiced using various computer system configurations and across one or more computers, including but not limited to clients and servers in a client-server relationship. Computers encompass all kinds of apparatus, devices, and machines for processing data, including by way of example, one or more programmable processors, memory, and can optionally include, in addition to hardware, computer programs and the ability to receive data from or transfer data to, or both, mass storage devices. A computer program, which may also be referred to or described as a program, software, a software application, an app, a module, a software module, a script, or code, can be written in any form of programming language, including compiled or interpreted languages, or declarative or procedural languages; it can be deployed in any form, including as a stand-alone program or as a module, component, subroutine, or other unit suitable for use in a computing environment deployed or executed on one or more computers.

Unless otherwise defined, all terms (including technical and scientific terms) used herein have the same meaning as commonly understood by one having ordinary skill in the art to which this invention belongs. In describing the invention, it will be understood that a number of techniques and steps are disclosed. Each of these has individual benefits, and each can also be used in conjunction with one or more, or in some cases all, of the other disclosed techniques. Accordingly, for the sake of clarity, this description will refrain from repeating every possible combination of the individual steps in an unnecessary fashion. The specification and claims should be read with the understanding that such combinations are entirely within the scope of the invention and the claims.

It will nevertheless be understood that no limitation of the scope is thereby intended, such alterations and further modifications in the illustrated invention, and such further applications of the principles as illustrated therein being contemplated as would normally occur to one skilled in the art to which the embodiments relate. The present disclosure is to be considered as an exemplification of the invention, and is not intended to limit the invention to the specific embodiments illustrated by the figures or description below.

Semantic frame identification involves associating identified target words in the sentential context of their natural language source with semantic frames from a frame lexical database. The disclosed invention utilizes a transformer for semantic frame identification of a target word in a natural language input. Through the transformer's multi-headed attention mechanism, the model learns contextual relationships between words in an input text. The disclosed invention generates a list of potential substitute words for a target word and then verifies the context and meaning of the words in the list to identify a frame from a frame lexical database.

System, method, apparatus, and program instruction for identifying a semantic frame of a target word in a natural language text is provided. Such an invention allows for the more efficient processing of natural language data, improving both the generalizability and accuracy of frame identification. The disclosed invention leverages the transformer architecture for improved semantic frame identification of a target word in a natural language input. This is done by an encoder generating a list of potential substitute words for a target word and a decoder and attention layer or neural network layer verifying the validity of the substitute words. An explanation for identifying a semantic frame from a frame lexical database based on the identified target word in the context of the text using a transformer follows.

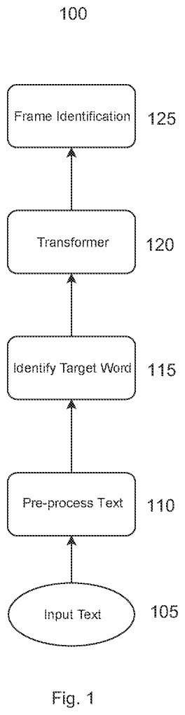

As illustrated in FIG. 1, a system embodiment 100, configured to identify a semantic frame, is provided. Such a system can have installed on it software, firmware, hardware, or a combination of them that in operation causes the system to perform operations or actions. The system receives, as input, a natural language text 105 stored in memory or accessed from another computer. While the input in the preferred embodiment is a sentence, this disclosure contemplates different natural language text lengths and formats as input. It is understood that the use of ‘sentence’ throughout this disclosure includes different natural language text lengths and formats, and no limitation is intended. In the preferred embodiment, the input text is pre-processed 110 using different NLP libraries to identify the target word 115 from the text. While other semantic role labeling or semantic parsing models use the word “predicate” as the target of the semantic role labeling or semantic parsing, it should be understood that the target word, as described here, can be any word in the input, and as such is not limited to verbs. Pre-processing can also include the identification of linguistic features, which can include part-of-speech tagging, whereby words are marked corresponding to their part of speech. Pre-processing can be performed by a pre-processing module, the location of which can be local to the transformer or separate.

In the preferred embodiment, the transformer 120 receives the input sentence with the target word masked. The transformer generates a list of potential substitute words for the masked target word and then verifies the context and meaning of the potential substitute words in the list to identify a frame from a frame lexical database. In the preferred embodiment, the system identifies a frame 125 for the target word from the FrameNet database corresponding to the target word in the context of the input text. Although configured for the FrameNet database, the system can be configured for use with other frame, semantic role, or similar databases, registries, or other datastores. Embodiments may vary in whether the database is located on the same physical device, integrated programmatically, or connected via a network.

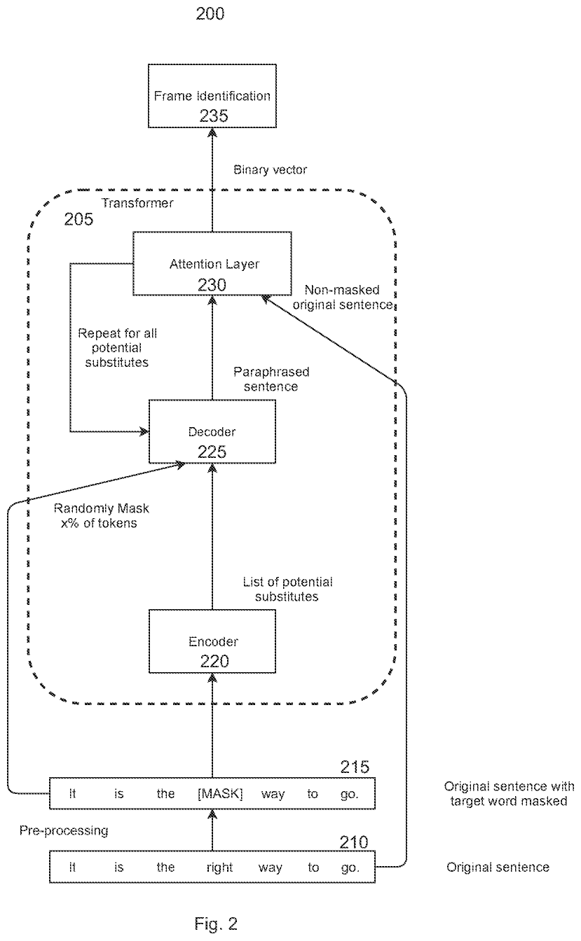

As illustrated in FIG. 2, a process 200 of identifying a semantic frame using a transformer is provided. A transformer 205 appropriately configured in accordance with this specification can perform the disclosed processes and steps. An embodiment of the transformer can include an encoder, decoder, and additional attention layer. The processes and steps described below can be performed by one or more computers or computer components or one or more computer or computer components executing one or more computer programs to perform functions by operating on input and generating output.

Natural language text is comprised of words, exemplified by the sentence “It is the right way to go.” The input sentence in the depicted embodiment is an example, and no limitation is intended. The input sentence 210 is pre-processed to identify the target word and other linguistic features. The target word is masked, i.e. replaced with a mask token, in the input sentence 215. The transformer 205 is configured to receive a natural language text with the target word masked.

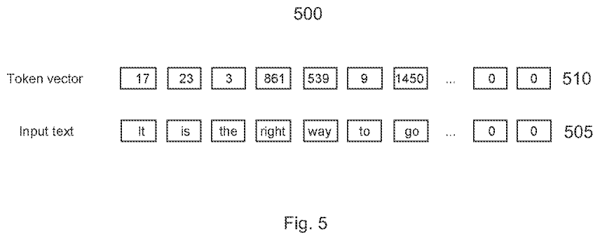

Because the model cannot read and understand text, the data is converted into numerical representations called tokens. In the preferred embodiment, tokens are scalars, but tokens can also be vectors, and no limitation is intended. As illustrated in FIG. 5, the process 500 whereby each word in the input sentence (“It is the right way to go”) 505 passed to a transformer is first converted to tokens (Eₓ) 510 is provided. In the preferred embodiment, the transformer is designed to accept a vector length of 512 tokens (I_{L}). When receiving an input less than 512 words in length, tokens following the sentence (that do not correspond to a word) are populated with the value of zero. Thus, for the example sentence, “It is the right way to go,” seven tokens having values corresponding to the words and 505 tokens having value 0 comprise the token vector. This disclosure contemplates transformers having different maximum and minimum length token vectors and those capable of receiving variable length token vectors. This disclosure contemplates the conversion of natural language data 505 to tokens 510 by a tokenizer or as part of pre-processing where the transformer would receive the token vector as input. The conversion of natural language data to tokens can be local to the transformer 205 or separate. The format of the token vector can vary to additionally include other values that the system may use (with appropriate delimiters), but should at least contain the words of the sentence as tokens.

The transformer 205 is comprised of the standard transformer components—an encoder and decoder—and an additional attention layer. Training of the transformer is done by passing a known input, generating an output using the transformer as it currently is, then comparing it to the known correct output, and modifying the transformer accordingly to improve the accuracy of the results. Over time, the transformer is trained to generate the known output for all natural language data input. In the preferred embodiment, the training is self-supervised due to the model's ability to check its own results.

The word tokens are received by the encoder 220, which functions like a masked language model. The encoder has N_encoder layers, which in the preferred embodiment is 12. Generally, increasing the number of encoder layers increases accuracy, though with diminishing returns, but reduces speed and efficiency. Each encoder layer consists of a multi-head attention layer, having H_encoder attention heads, which in the preferred embodiment is 12, and a feed forward layer. The encoder utilizes multi-head attention, which is attention with separate learnable parameters run in parallel. The multi-head attention layer compares each token to every other token in the input sentence, creating an output score. The output score is fed into the feed forward layer. The output of the feed forward layer is a vector that is the length of a language dictionary, which is the complete English language in the preferred embodiment, though no limitation is intended as to the size and language of the language dictionary. Each element in the vector is a value or score, a probability in the preferred embodiment, indicating whether or not the corresponding word in the language dictionary is a potential substitute word for the target word. The encoder generates a list (vector) of potential substitute words for the target word, ordered by the scores, such that the most probable substitute is at the top of the list. The number of words in the list can be a set number (e.g. the top 10 words), or alternatively, a threshold score can be set, whereby words having a higher output score than the threshold are included in the list. The encoder additionally can determine encoder word embeddings of the input text. In the preferred embodiment, each word embedding is a vector, so the vector of encoder word embeddings is a vector of vectors. Embeddings can also be scalars, and no limitation is intended.

The next component of the transformer is the decoder 225, which functions like a paraphraser. The decoder has N_decoder layers, which in the preferred embodiment is 12. Each decoder layer consists of a masked multi-head attention layer with H_decoder_1 attention heads, a multi-head attention layer with H_decoder_2 attention heads, and a feed forward layer. In the preferred embodiment, H_decoder_1 and H_decoder_2 are both 12. Masked multi-head attention is a multi-head attention layer which masks the input tokens so that only the previous words in the input are known and compared. The output from masked multi-head attention is fed into multi-head attention, which the decoder utilizes to generate an output score, which is fed into the feed forward layer. The result of the feed forward layer is a word prediction.

The decoder generates a new sentence sequence, where the sequence is generated one word at a time in an autoregressive manner. Each next word in the sequence is generated using the current sequence, such that the output of the decoder becomes the input for the decoder to generate the next word in the sequence. The decoder receives as input the original input sentence, with the target word replaced by a word in the potential substitute list and x % of the remaining word tokens randomly masked, and the encoder word embeddings of the input sentence from the encoder. In the preferred embodiment, x % is 50%.

From the masked input sentence, and using the encoder word embeddings of the input sentence, the decoder generates a new sentence by predicting a replacement word for each word in the sentence. The model is forced to predict the substitute word at the position of the target word. For the predictions of the non-masked words, the model can be forced to predict the non-masked word. In the preferred embodiment, for the non-masked words, the model predicts a replacement word, as it does for masked words. The model then takes an average of the predicted word and the original non-masked word. Note that, in the model, the words were converted to embeddings, meaningfully placed in the vector space. Therefore, the average of two word embeddings is mathematically the average of two vectors, which results in a meaningful average of the meanings of the two words. The average value replaces the predicted value in the input for the next value in the sequence. In this way, the decoder generates a paraphrased sentence, which is a paraphrase of the original input sentence, with the potential substitute word.

The paraphrased sentence, generated with a potential substitute word by the decoder, is fed into an attention layer 230 along with the original input sentence 210 in the form of encoder word embeddings for sentence comparison. This attention layer is an additional layer separate from the encoder and decoder of the transformer. The attention layer determines if the paraphrased sentence and the original input sentence are a contextual match. A Siamese network is utilized, whereby the concatenated inputs are fed through identical copies of the same network. The attention layer has H_attention attention heads, which in the preferred embodiment is 12, so each network has the same 12 attention heads. There is a linear/feed forward layer following the Siamese network. If the model determines that the two sentences are a contextual match, the attention layer outputs a 1, and if not, the attention layer outputs a 0.

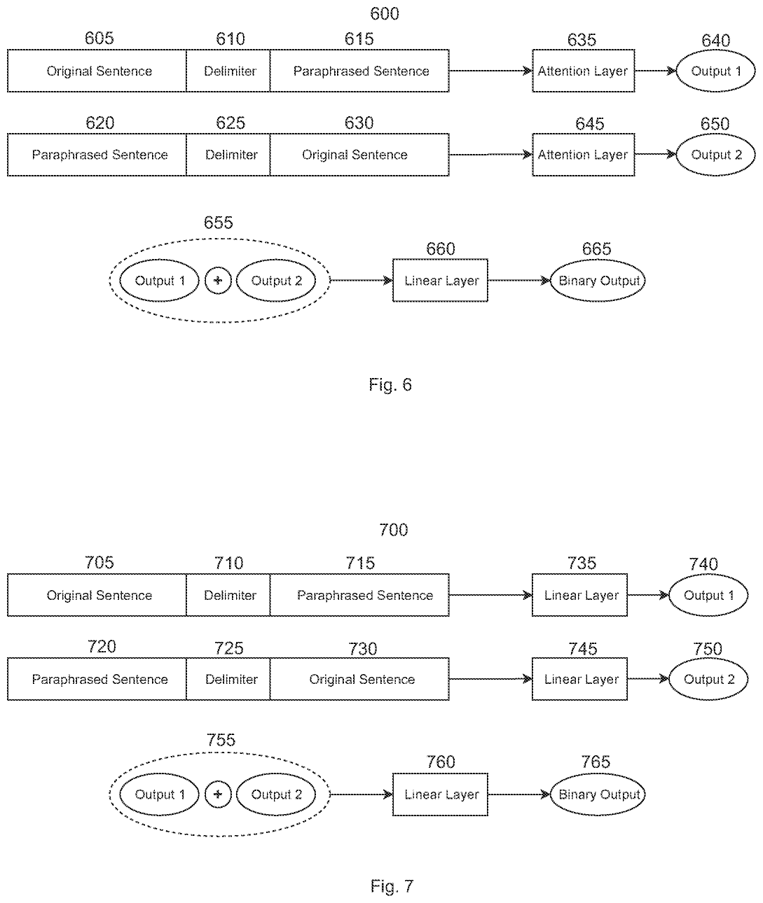

As depicted in FIG. 6, the sentence comparison process 600 performed by the attention layer is provided. A first concatenated input is created from the original sentence 605 followed by a delimiter 610 followed by the paraphrased sentence 615. A second concatenated input is created from the paraphrased sentence 620 followed by a delimiter 625 followed by the original sentence 630. The first concatenated input is fed through the attention layer 635 resulting in a first output 640. The second concatenated input is fed through the attention layer 645 resulting in a second output 650. The two outputs are concatenated 655, and the result of the concatenation is fed through a linear/feed forward layer 660 resulting in the binary output 665.

The model considers both orderings of the original and paraphrased sentences when comparing the two. This is done so that the mathematical model does not artificially infuse meaning into the order in which the original and paraphrased sentences are concatenated.

For each word on the potential substitute word list, the model generates a paraphrased sentence in the decoder 225 and then compares it to the original sentence in the attention layer 230, iterating over the decoder and the attention layer. The result of each comparison is a 1 or 0, indicating whether or not the potential substitute is a valid substitute. The results are inserted into a binary vector, where the nth entry in the vector corresponds to whether or not the nth potential substitute in the list is a valid substitute.

In alternative embodiments, the decoder generates a list of paraphrased sentences, which are each a paraphrase of the original input sentence, with the corresponding potential substitute word, for all of the potential substitute words in the list. Then, the paraphrased sentences, each generated with the corresponding potential substitute word by the decoder, are all fed into the attention layer along with the original input sentence in the form of encoder word embeddings for sentence comparison. For every word in the potential substitute word list, the model compares the corresponding paraphrased sentence to the original sentence in the attention layer, iterating within the attention layer.

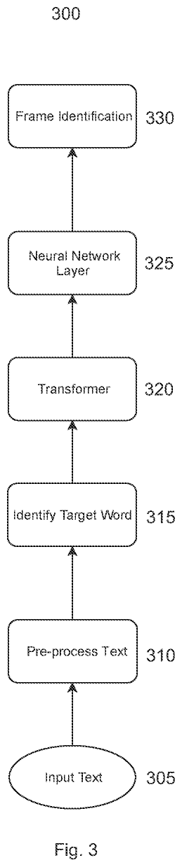

As illustrated in FIG. 3, an alternative system embodiment 300, configured to identify a semantic frame, is provided. The input text 305 is pre-processed 310 using different NLP libraries to identify the target word 315 from the text, and other linguistic features can also be identified as part of pre-processing. The transformer 320 receives the input sentence with the target word masked. The transformer generates a list of potential substitute words for the masked target word. Instead of being performed by an attention layer that is part of the transformer, a separate neural network layer 325 verifies the context and meaning of words in the list of potential substitute words to identify a frame from a frame lexical database. In the preferred embodiment, the system identifies a frame 330 for the target word from the FrameNet database corresponding to the target word in the context of the input text.

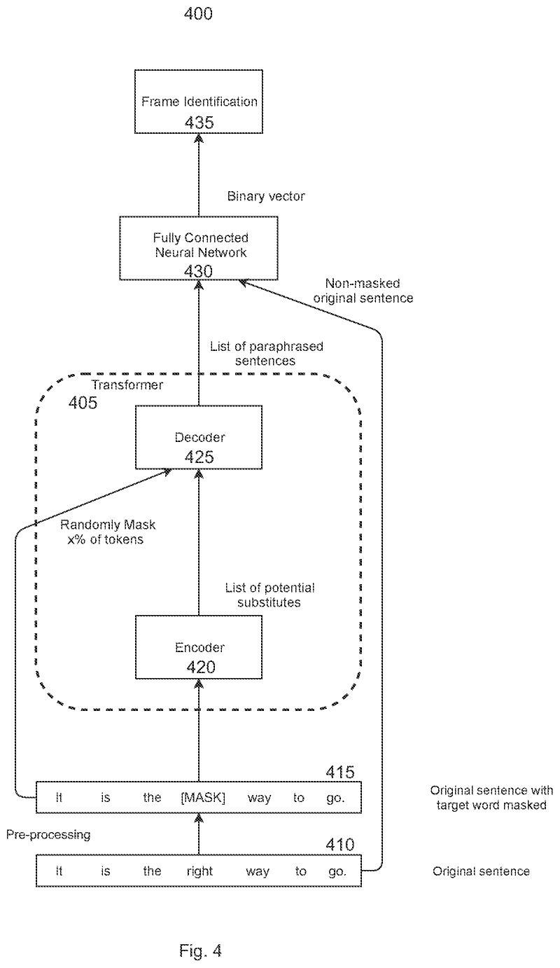

As illustrated in FIG. 4, a process 400 of identifying a semantic frame using a transformer 405 and neural network layer 430 is provided. A transformer and neural network layer appropriately configured in accordance with this specification can perform the disclosed processes and steps. An embodiment of the transformer can include an encoder and decoder.

Similar to the embodiment depicted in FIG. 2, the input sentence 410 is pre-processed to identify the target word and other linguistic features. The target word is masked in the input sentence 415. The transformer 405 is configured to receive a natural language text with the target word masked. Because the model cannot read and understand text, the data is converted into numerical representations called tokens.

The transformer 405 is comprised of the standard transformer components—an encoder and decoder. The token vector is received by the encoder 420, which functions like a masked language model. The encoder generates a list (vector) of potential substitute words for the target word, ordered by the scores, such that the most probable substitute is at the top of the list. The decoder 425 outputs a paraphrased sentence for each potential substitute word in the list from the encoder, to create a list of paraphrased sentences.

The list of paraphrased sentences, generated with each potential substitute word by the decoder, is fed into a neural network layer 430 along with the original input sentence 410 in the form of encoder word embeddings for sentence comparison. The neural network layer is a fully connected neural network, separate from the transformer. The neural network layer compares each of the paraphrased sentences to the original input sentence, determining whether or not it is a contextual match. The neural network has N_neural layers, which in the preferred embodiment is 2, followed by a linear/feed forward layer. Each of the N_neural layers is identical. The output of each sentence comparison, a 1 or 0, is inserted into a binary vector, where the nth entry in the vector corresponds to whether or not the nth potential substitute word in the list is a valid substitute.

As depicted in FIG. 7, the sentence comparison process 700 performed by the neural network layer is provided. A first concatenated input is created from the original sentence 705 followed by a delimiter 710 followed by the paraphrased sentence 715. A second concatenated input is created from the paraphrased sentence 720 followed by a delimiter 725 followed by the original sentence 730. The first concatenated input is fed through a linear layer 735 resulting in a first output 740. The second concatenated input is fed through a linear layer 745 resulting in a second output 750. The two outputs are concatenated 755, and the result of the concatenation is fed through a linear/feed forward layer 760 resulting in the binary output 765. For every word in the potential substitute word list, the model compares the corresponding paraphrased sentence to the original sentence in the neural network layer, iterating within the neural network layer.

In alternative embodiments, for each word in the potential substitute word list, the model generates a paraphrased sentence in the decoder and then compares it to the original sentence in the neural network layer, iterating over the decoder and the neural network layer.

From the binary vector generated in both system embodiments, the model can output the list (vector) of all valid substitutes or of the first k valid substitutes, which are the first k words corresponding to the first k 1s in the binary vector. The list of potential substitute words was ordered based on the encoder output score, such that selecting first k valid substitutes is selecting the top k best substitutes. The model can further look at the complete list of frames of each of the top k valid substitutes and find the frame most in common among the top k valid substitutes. K can be a fixed number or variable. The frame most in common among the top k valid substitutes can be retrieved from the lexical frame database and is identified 235, 435 as the frame corresponding to the target word in the context of the input text. This post-processing can be performed by a post-processing module, the location of which can be local to the transformer or separate.

The preceding description contains embodiments of the invention, and no limitation of the scope is thereby intended. It will be further apparent to those skilled in the art that various modifications and variations can be made in the present invention without departing from the spirit or scope of the invention.

1. A computer-implemented method for identifying a semantic frame of a target word in a natural language text, comprising:
receiving, into a transformer, a token vector, wherein the token vector contains tokens representing words in a natural language input text;
generating one or more potential substitute words for the target word;
generating, for each potential substitute word, a paraphrased text, that is a paraphrase of the input text with each potential substitute word;
comparing each paraphrased text to the input text to determine whether the potential substitute word is a valid substitute word;
identifying one or more valid substitute words for the target word, from the one or more potential substitute words.

2. The method of claim 1, wherein the generated potential substitute words are ordered by an output score.

3. The method of claim 2, wherein the identified valid substitute words are the top k valid substitutes.

4. The method of claim 1 further comprising:
identifying the semantic frame most in common among the valid substitute words.

5. The method of claim 1 further comprising:
before receiving, into a transformer as input, a token vector:
a) receiving, as input, a natural language text;
b) converting words in the natural language text into tokens and inserting the tokens into a token vector.

6. The method of claim 5, wherein converting words in the natural language text into tokens includes populating, with the value of zero, any tokens in the vector that do not correspond to a word.

7. The method of claim 1 further comprising:
before receiving, into a transformer as input, a token vector:
a) receiving, as input, a natural language text;
b) pre-processing the natural language text to identify a target word;
c) converting words in the natural language text into tokens and inserting the tokens into a token vector.

8. The method of claim 1 further comprising:
before receiving, into a transformer as input, a token vector:
a) receiving, as input, a natural language text;
b) pre-processing the natural language text to identify a target word and features of the text;
c) converting words in the natural language text into tokens and inserting the tokens into a token vector.

9. A system for identifying a semantic frame of a target word in a natural language text, comprising at least one processor, the at least one processor configured to cause the system to at least perform:
receiving, into a transformer, a token vector, wherein the token vector contains tokens representing words in a natural language input text;
generating one or more potential substitute words for the target word;
generating, for each potential substitute word, a paraphrased text, that is a paraphrase of the input text with each potential substitute word;
comparing each paraphrased text to the input text to determine whether the potential substitute word is a valid substitute word;
identifying one or more valid substitute words for the target word, from the one or more potential substitute words.

10. The system of claim 9, wherein the generated potential substitute words are ordered by an output score.

11. The system of claim 10, wherein the identified valid substitute words are the top k valid substitutes.

12. The system of claim 9 further comprising:
identifying the semantic frame most in common among the valid substitute words.

13. The system of claim 9 further comprising:
before receiving, into a transformer as input, a token vector:
a) receiving, as input, a natural language text;
b) converting words in the natural language text into tokens and inserting the tokens into a token vector.

14. The system of claim 9 further comprising:
before receiving, into a transformer as input, a token vector:
a) receiving, as input, a natural language text;
b) pre-processing the natural language text to identify a target word;
c) converting words in the natural language text into tokens and inserting the tokens into a token vector.

15. The system of claim 9 further comprising:
before receiving, into a transformer as input, a token vector:
a) receiving, as input, a natural language text;
b) pre-processing the natural language text to identify a target word and features of the text;
c) converting words in the natural language text into tokens and inserting the tokens into a token vector.

16. A system for identifying a semantic frame of a target word in a natural language text, comprising:
a transformer configured to receive a token vector, wherein the token vector contains tokens representing words in a natural language text;
the transformer having:
an encoder configured to generate one or more potential substitute words for the target word;
a decoder configured to generate, for each potential substitute word, a paraphrased text, that is a paraphrase of the input text with each potential substitute word;
an attention layer configured to compare each paraphrased text to the input text to determine whether the potential substitute word is a valid substitute word;
whereby the transformer identifies one or more valid substitute words for the target word, from the one or more potential substitute words.

17. The system of claim 16 further comprising:
a post-processing module configured to identify the semantic frame most in common among the valid substitute words.

18. The system of claim 16 further comprising:
a pre-processing module configured to:
a) receive, as input, a natural language text;
b) convert words in the natural language text into tokens and insert the tokens into a token vector.

19. The system of claim 16 further comprising:
a pre-processing module configured to:
a) receive, as input, a natural language text;
b) pre-process the natural language text to identify a target word;
c) convert words in the natural language text into tokens and insert the tokens into a token vector.

20. The system of claim 16 further comprising:
a pre-processing module configured to:
a) receive, as input, a natural language text;
b) pre-process the natural language text to identify a target word and features of the text;
c) convert words in the natural language text into tokens and insert the tokens into a token vector.
